(19) United States
(12) Patent Application Publication
(10) Pub. No.: US 2009/0243426 A1
(43) Pub. Date: Oct. 1, 2009

(54) ELECTROSTATIC DEVICE FOR DISPLACING AN OBJECT

(75) Inventors: Funda Sahin Nomaler, Eindhoven (NL); Johan Cornelis Compter, Eindhoven (NL); Piet Van Der Meer, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 11/721,696

(22) PCT Filed: Dec. 12, 2005
(86) PCT No.: PCT/IB2005/054186

§ 371 Date: Jun. 14, 2007

(30) Foreign Application Priority Data
Dec. 16, 2004 (EP) 04106621.8

(51) Int. Cl. H02N 1/08

(52) U.S. Cl. 310/300

(57) ABSTRACT

Electrostatic displacement devices (1) with high forces and high accelerations are provided by arranging the electrodes (31, 31a, 31b) such that an electric field is generated extending over an area equivalent to the surface area of the object (2) to be displaced. Preferably, higher voltages are applied to the electrodes (31a) in the edge region than to the electrodes (31b) in the middle region, to further increase the shear forces inducing the actual displacement.

The present invention relates to an electrostatic device for displacing an object, with a plurality of electrodes. Such devices can be used, for example, for displacing semiconductors and non ferromagnetic metals thanks to electrostatic forces in semiconductor device manufacturing or manufacturing of computer components.

The present invention further relates to a method for controlling such an electrostatic device.

Particularly in the field of semiconductor and computer manufacture, it is important to transport components in a frictionless and contactless manner to reduce contamination of product surfaces by particles. Components of ferromagnetic material can be magnetically levitated, but most components are of semiconductor or non ferromagnetic material.

In J. Jin et al., “Direct Electrostatic Levitation and Propulsion”, IEEE Transactions on Industrial Electronics, Vol. 44, No. 2, April 1997, pp. 234-239, which is hereby incorporated as reference to be understood in connection with the present invention, a new mechanism is disclosed that can directly levitate and drive an object via electrostatic forces. This works especially for conductive, but not ferromagnetic materials like e.g. silicon or aluminum. In J. Jin et al. an aluminum disk or a silicon wafer is displaced in one direction with the help of stripe-shaped electrodes that are arranged orthogonally to the direction of displacement. By applying a voltage to the electrodes overlapping with the disk, shear forces are generated at the edge of the disk, leading to a displacement of the disk. The electrodes can be controlled individually, particularly have a voltage applied to individually

The disk and the electrodes cooperating can be considered as being an electrostatic motor, where the disk is the mover and the electrodes are the stator. Unfortunately, compared with conventional electric motors, they have relatively low forces, which means lower accelerations. But most applications in semiconductor industry require high speed.

There is therefore a need for an electrostatic displacement device with increased force to meet the requirements of the semiconductor industry.

The present invention is therefore directed towards providing such an electrostatic displacement device.

According to the invention there is provided an electrostatic device for displacing an object, with a plurality of electrodes, wherein the electrodes are arranged such that an electric field is generated extending over an area equivalent to the surface area of the object to be displaced.

The invention is based on the idea, that one possibility to increase the force acting between an object to be displaced and electrodes of an electrostatic displacement device is to increase the energy stored in the system object-electrodes. This energy Wₑₗ is in first approximation equal to

$${W}_{eI} = \frac{1}{2} \cdot C \cdot {U}^{2}$$

with U the voltage applied to the electrodes and C the capacitance of the system object-electrodes. For equal voltages U, the energy Wₑₗ can be increased by increasing the capacity C. One way to increase the capacity C independently of the material of the electrodes or particularly the material of the object to be displaced, is to change the geometry of the system object-electrodes. An increase of capacitance C can be achieved by minimizing the difference between the area of electrodes with voltage applied to and the surface area of the object to be displaced.

Furthermore, the force acting in one direction being a derivative of the energy in this direction, the force can also be increased by providing a larger change of capacitance. By adapting the area generating an electric field to the surface area of the object to be displaced, a larger change in capacitance is provided in the region of the edge of the object to be displaced. Displacement is considered here as movement not only in the plane of, but also perpendicular with respect to the object to be displaced.

In electrostatic displacement devices the stripe shape of the electrodes leads to a basically rectangular area of electrodes with voltage applied to, whereas the most common object to be displaced, a wafer, has a disk-like shape, thus a circular surface area.

The present invention is based on the approach of optimizing the force of an electrostatic motor using an electrostatic displacement device by optimizing the match between the shape of surface area of the object to be displaced and the shape of the area where an electric field is generated by applying a voltage to some of the electrodes of the electrostatic displacement device.

Preferably, the shape, and/or the configuration of which electrode has a voltage applied to, is adapted to the contour of the object to be displaced. In this way the displacement device can easily be adapted to utilization in a linear or planar configuration and for objects having a multitude of various shapes.

In some preferred embodiments of the present invention, the device is optimized for displacing a circular object by having electrodes with the shape of an arc. This kind of embodiment is particularly advantageous for linear displacements. It has proven to be advantageous to additionally use auxiliary electrodes that are arranged next to the arc-shaped electrodes and parallel to the direction of displacement to increase the ability of control of the displacement movement.

In other preferred embodiments of the present invention, the electrodes have the shape of cells, preferably of quadratic, hexagonal or triangular shape to optimally make use of the area in the plane of the electrodes. This kind of embodiment is particularly advantageous for planar configurations and for displacing objects of various shapes only by changing the configuration of to which electrodes to apply a voltage.

It has further proven to be advantageous not to apply voltages of the same magnitude, having the same or different polarity, to all electrodes indifferently, but to apply voltages such that the electrodes located at the edge of the area equivalent to the surface area of the object to be displaced have another voltage applied to as the electrodes located in the middle of the area equivalent to the surface area of the object to be displaced. This allows to choose a voltage for generating levitation forces over most of the surface of the object to be displaced and to optimize the voltage at the edges for optimal shear forces that induce the actual displacement. In other words, this approach lows control over the three directions X, Y, Z in the plane of and perpendicular to the object to be displaced, as well as control over the rotation around axes in the plane of the object to be displaced.

In a further aspect, a method of control of an electrostatic device according to the invention is provided, wherein a voltage of another magnitude is applied to electrodes located at the edge of the object to be displaced than to electrodes located near the center of the object to be displaced. As already explained, choosing voltages of different magnitudes for different electrodes enables control over the object to be displaced in the three linear directions and over the rotational axes in the plane of the object to be displaced, i.e. over shear forces and levitational forces.

A detailed description of the invention is provided below. Said description is provided by way of a non-limiting example to be read with reference to the attached drawings in which:

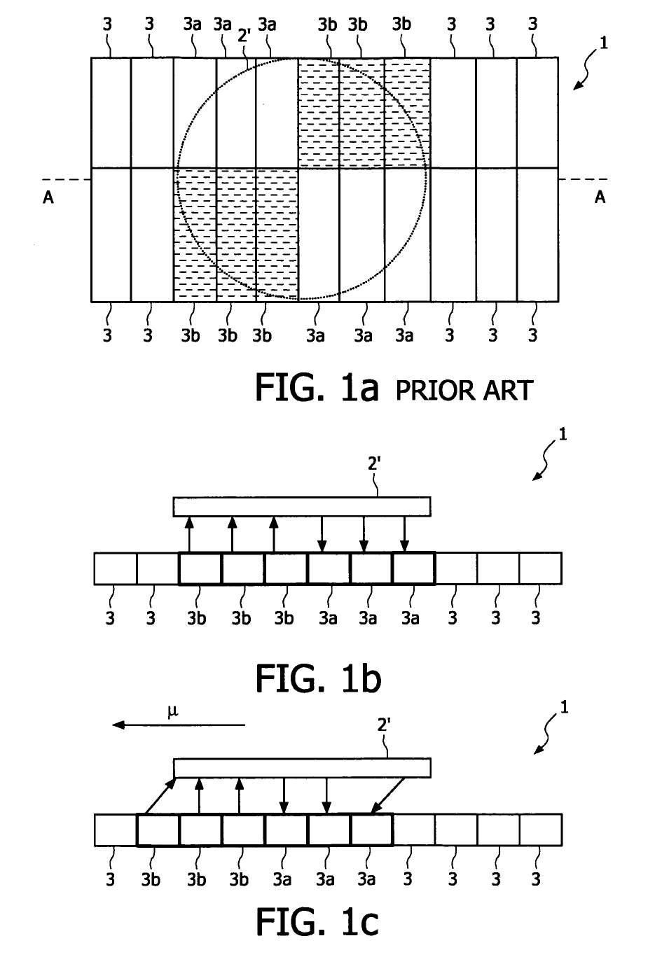

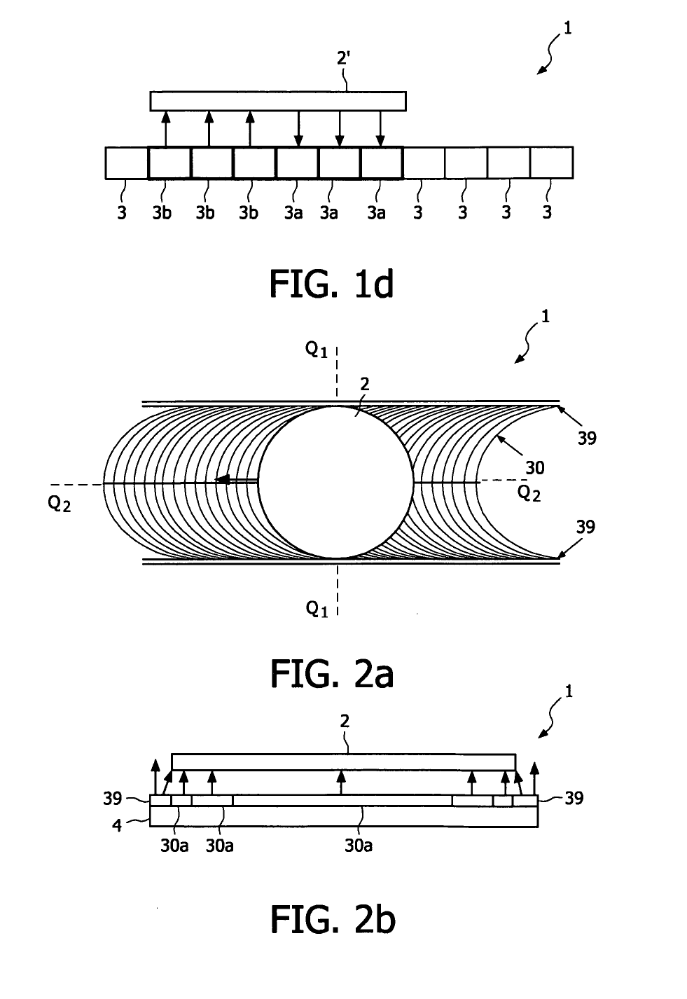

FIG. 1a shows schematically an electrostatic displacement device according to prior art;

FIGS. 1b-d show schematically the basic principle a an electrostatic displacement device;

FIG. 2a shows schematically top view of a first embodiment of the present invention;

FIG. 2b shows schematically a cut of the embodiment of FIG. 2a along the line Q1-Q1;

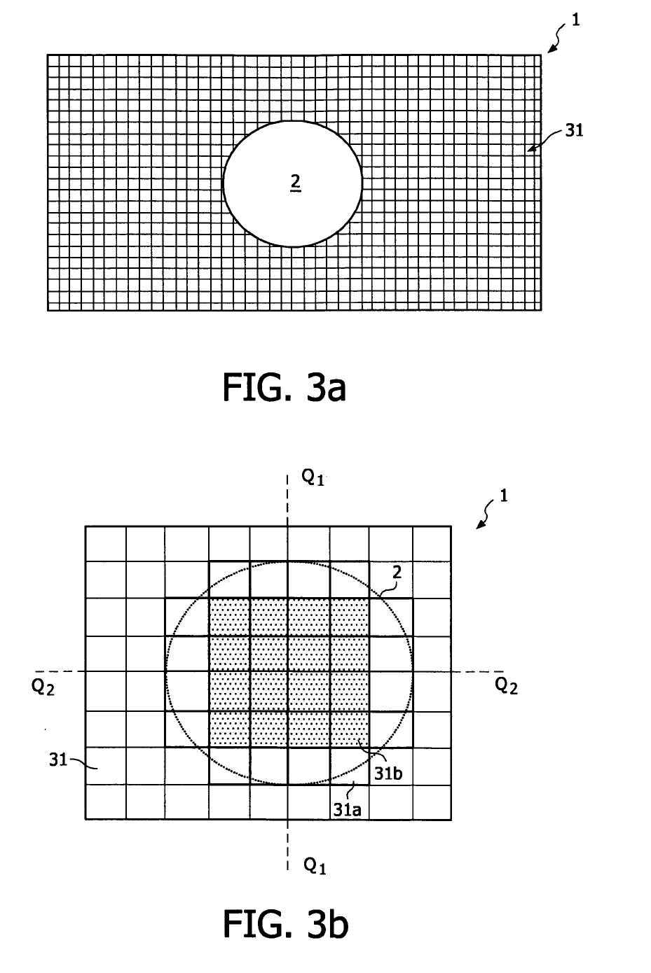

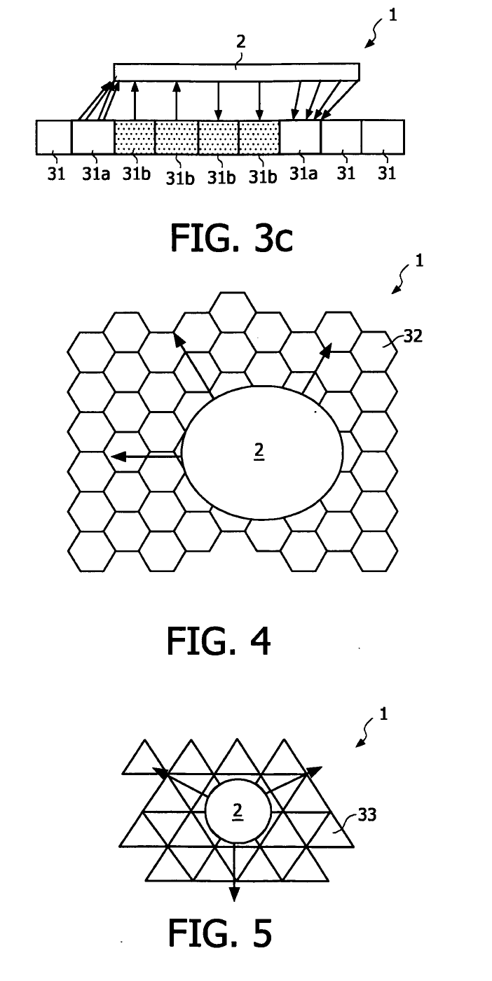

FIG. 3a shows schematically a top view of a second embodiment of the present invention;

FIG. 3b shows schematically an enlarged top view the second embodiment;

FIG. 3c shows schematically a cut of the embodiment of FIG. 3b along the line Q2-Q2;

FIG. 4 shows schematically a third embodiment of the present invention; and

FIG. 5 shows schematically a fourth embodiment of the present invention.

FIG. 1 shows schematically a top view of an electrostatic displacement device 1 according to prior art with stripe-shaped electrodes 3, 3a, 3b. The contour of aluminum hard disk 2′ to be displaced is shown as dotted line. The twelve electrodes 3a, 3b (with bolder boundary lines) that are overlapping with the aluminum disk 2′ have a voltage applied to. Each electrode 3, 3a, 3b can be controlled individually, especially have a voltage applied to independently of the neighboring electrodes.

To keep the overall potential of the aluminum disk 2′, some electrodes 3a are excited with a positive voltage and other electrodes 3b are excited with voltage of the same magnitude, but negative (area with short lines).

To avoid a tilting of the aluminum disk 2′, there are four regions of either positive or negative voltage that are distributed over the overall area to compensate each other. Of course, there could be more than four area parts. The essential point is the even distribution of the regions over the overall area.

One possibility of fabricating an electrostatic displacement device 1, is to deposit e.g. copper electrode structures on for example a glass epoxy printed circuit board. There should always be a small gap between two electrodes to avoid interferences, especially if one electrode 3a is positive and the other electrode 3b is negative. Electronic components such as control units and power supplies have been omitted in FIG. 1a to emphasize the basic principle of the electrostatic displacement device 1 as such and are well known to the person skilled in the art.

The FIGS. 1b to 1d show a cut view of FIG. 1 along the line A-A to illustrate, how the electrostatic displacement 1 device works.

FIG. 1b shows the state where the electrodes 3a, 3b overlapping with the disk 2′ have a voltage applied to, leading to levitation of the disk 2′. In a next step, each electrode 3, 3a, 3b is switched such that the set of electrodes 3a, 3b having a voltage applied to are displaced with respect to the disk 2′ in the direction (arrow M) of the intended displacement. This induces shear forces acting from the outermost electrodes 3a, 3b on the edges of the disk 2′. The disk 2′ reacts to these shear forces by moving one electrode width in direction of the arrow M to be again in a state where only levitational forces are acting, as shown in FIG. 1d.

Back to FIG. 1a, the mismatch between the area of electrodes 3a, 3b having a voltage applied to them and inducing an electric field and the surface area of the disk 2′ is clearly to be seen, as more than 21% of the electrodes' area is not directly overlapping with the disk 2′.

FIG. 2a shows schematically a top view of a first embodiment of the present invention, which is particularly well adapted for linear displacement of disk shaped objects, e.g. a wafer 2. The electrodes 30 have the shape of an arc, the width of the arc's opening angle will be chosen according to the actual application. The orientation of the arc-shaped electrodes 30 is such that there is an optimal match between the shape of the electrodes 30 and the contour of the wafer 2 in direction of the intended displacement (see arrow parallel to line Q2 Q2). As the shear forces along the edges are most important for the actual displacement of the wafer 2 the capacity respectively the change in capacity along the direction of displacement has been optimized to increase the forces acting on the wafer 2 and thus the acceleration acting on it.

Analogously, for an object to be moved having another shape than circular, the shape of the electrodes can be chosen accordingly to fit with the contour of the object in displacement direction.

The embodiment of the electrostatic displacement device 1 shown in FIG. 2a can be operated with four or more regions of different polarities of the applied voltage as in the state of the art. Another possibility is to apply to all arc-shaped electrodes 30 voltage of the same polarity and to use auxiliary electrodes 39 for enhancing the control of the displacement movement. The auxiliary electrodes 39 are arranged next to the arc-shaped electrodes 30 and parallel to the direction of intended displacement. It is possible to use two long electrodes or several electrodes arranged in a line as auxiliary electrodes 39.

The effect of the auxiliary electrodes 39 together with the arc-shaped electrodes 30a that have a voltage applied to is shown in FIG. 2b, a cut along the line Q1-Q1 of FIG. 2a. The auxiliary electrodes improve the levitational effect and make sure that the wafer 2 does not move in the wafer plane in the direction perpendicular to the direction of the displacement.

FIG. 3a shows another embodiment of the present invention, an electrostatic displacement device 1 with electrode cells 31 having a quadratic shape. This kind of electrostatic displacement device 1 can be used not only for linear displacements but for displacements in a two-dimensional plane. Thanks to using electrode cells 31, one displacement device 1 can be used for objects of different shapes. Only the configuration of to which electrode cells 31 to apply a voltage has to be adapted depending on the actual shape of the object to be displaced. The smaller the electrode cells 31 are, the wider the variety of possible movements and objects to be displaced. Of course, in actual applications, there will be a compromise to be made on variety of possible movements and objects on the one hand, and complexity and cost of the electronic components on the other hand.

This kind of embodiment is shown enlarged in FIG. 3b. The wafer 2 to be displaced is shown by the dotted line. The electrode cells 31a, 31b having a voltage applied to (e.g. in the known four regions manner, with the boundaries being defined by lines Q1-Q1 and Q2-Q2, or more than four regions) are shown with a bold boundary line compared with the electrode cells 31 that have no voltage applied to. Again, there is a better match between the area with generated electric field and the surface area of the wafer 2, particularly in the region of the edges, than in electrostatic displacement devices according to prior art.

The example illustrated in FIGS. 3b and 3c has the additional special feature, that not the same magnitude of voltage is applied to electrode cells 31a in the edge region and electrode cells 31b in the inner region (dotted area) of the area with generated electric field. In the illustrated example, the voltage in the edge region has been chosen higher to induce particularly strong shear forces for the actual displacement of the wafer 2, as is shown schematically in FIG. 3c by using more arrows for electrode cells 31a with higher voltage. The voltage applied to the electrode cells 31b of the inner region is less, but enough to achieve levitation of the wafer 2.

It will be noted, that depending on the actual application, the levitation voltage may be higher than the shear force voltage, and that more than two different magnitudes of voltages may be applied to different regions.

FIGS. 4 and 5 show as well embodiments based on cellular electrodes 32, 33. In FIG. 4 the electrode cells 32 have a hexagonal shape and in FIG. 5 the electrode cells 33 have a triangular shape. The hexagonal embodiment of FIG. 4 is especially well adapted for movement in six directions, each 60° apart (see arrows), whereas the triangular embodiment is especially well adapted for movement in three directions, each 120° apart (see arrows). The shape of the electrode cells 31, 32, 33 may also be chosen depending on the shape of the object to be displaced.

Although having described several preferred embodiments of the invention, those skilled in the art would appreciate that various changes, alterations, and substitutions can be made without departing from the spirit and concepts of the present invention. The invention is, therefore, claimed in any of its forms or modifications with the proper scope of the appended claims. For example various combinations of the features of the following dependent claims could be made with the features of the independent claim without departing from the scope of the present invention. Furthermore, any reference numerals in the claims shall not be construed as limiting scope.

### LIST OF REFERENCE NUMERALS

1 electrostatic displacement device
2 wafer
2 hard disk
3 stripe-shaped electrode
3a stripe-shaped electrode with positive voltage applied to
3b stripe-shaped electrode with negative voltage applied to
30 arc-shaped electrode
30a arc-shaped electrode with voltage applied to
31 quadratic electrode cell
31a quadratic electrode cell with high voltage applied to
31b quadratic electrode with low voltage applied to
32 hexagonal electrode cell
33 triangular electrode cell
39 auxiliary electrode cell
A-A line
Q1-Q1 line
Q2-Q2 line
M arrow in direction of displacement

1. An electrostatic device (1) for displacing an object (2), with a plurality of electrodes (30, 31, 32, 33), wherein the electrodes (30, 31, 32, 33) are arranged such that an electric field is generated extending over an area equivalent to the surface area of the object (2) to be displaced.

2. The device of claim 1, wherein the shape, and/or the configuration of which electrode (30, 31, 32, 33) has a voltage applied to, is adapted to the contour of the object (2) to be displaced.

3. The device of claim 1 for displacing a circular object (2), wherein the electrodes (30, 30a) have the shape of an arc.

4. The device of claim 3, wherein additional auxiliary electrodes (39) are arranged next to the arc-shaped electrodes (30, 30a) and parallel to the direction (M) of displacement.

5. The device of claim 1, wherein the electrodes (31, 32, 33) have the shape of cells.

6. The device of claim 1, wherein the electrodes (31, 32, 33) have a quadratic, hexagonal or triangular shape.

7. The device according to claim 1, wherein the electrodes (31a) located at the edge of the area equivalent to the surface area of the object (2) to be displaced have a voltage of another magnitude applied to as the electrodes (31b) located in the middle of the area equivalent to the surface area of the object (2) to be displaced.

8. A method of control of an electrostatic device as claimed in claim 1, wherein a voltage of another magnitude is applied to electrodes located at the edge of the object to be displaced than to electrodes located near the center of the object to be displaced.
